(19) United States
(12) Patent Application Publication
(10) Pub. No.: US 2012/0240790 A1
(43) Pub. Date: Sep. 27, 2012

(54) Clip system for positioning a strainer basket within a cooking container

(76) Inventor: Agostino Difante, San Clemente, CA (US)

(21) Appl. No.: 13/136,118

(22) Filed: Jul. 25, 2011

Related U.S. Application Data
(60) Provisional application No. 61/465,581, filed on Mar. 22, 2011.

(51) Int. Cl. A47J 37/12

(52) U.S. Cl. 99/413

(57) ABSTRACT

Apparatus for cooking foods such as pasta or seafood including a container which receives a liquid to be heated and a cooking strainer basket positioned in the liquid for cooking within the container, the container and cooking basket having cooperating selectively positioned engaging support members for alternatively positioning of the cooking basket in the liquid for cooking of the food and repositioning of the cooking basket above the food to provide for straining of the food.

### CLAIM FOR BENEFIT OF EARLIER FILING DATE

This application claims the benefit of U.S. Provisional Application No. 61/465,581 filed on 22 Mar. 2011. This utility application has the same title, inventor and subject matter as the said Provisional Application.

### BACKGROUND

The background of the invention will be discussed in two parts.

1. Field of the Invention

The present invention relates in general to apparatus for cooking foods such as pasta and seafood and more particularly in relationship to a cooking container in combination with a strainer basket, the strainer basket having a support bracket cooperating with a clip on the container for alternative positioning of the basket within the container to provide for cooking or straining of the food.

2. Prior Art

Apparatus for cooking and/or straining of pasta and the like are known in the market. Although a variety of such apparatus is known, prior art apparatus is either too complex, is inefficient in use, or is uneconomical. Such a device of interest is disclosed in U.S. Design Patent Des. 353,303 which issued to Davis on 13 Dec. 1994, and relates to a combined cooking container having lid and a food strainer basket. It is thus a feature of the present invention to provide a new and improved cooking apparatus for cooking and straining food such as pasta and seafood that is more efficient and economical than prior art devices. It is another feature of the invention to provide cooking and food straining apparatus that does not require removal of the cooking basket from the container for straining of the food. Other objects of the invention will become apparent with a reading of the specification taken with the drawings wherein there is shown and described the apparatus of the invention.

### SUMMARY

The present invention provides apparatus for cooking foods such as pasta and the like and includes a container which receives a liquid to be heated and a cooking strainer-basket within the container which is submerged in the liquid for cooking. The container and strainer basket have a cooperating flange and clip system for positioning of the strainer basket in the cooking liquid for cooking of the food, and for repositioning of the basket above the liquid to provide for straining of the liquid in the food.

### DRAWINGS

FIG. 1 is an exploded perspective view of the cooking apparatus in accordance with the present invention;

FIG. 2 is a perspective view showing the strainer basket of FIG. 1 rotated 180 degrees from the position as shown in FIG. 1;

FIG. 3 is perspective view of the cooking apparatus of FIG. 1 illustrating the strainer basket support flange and bracket engaged with the container and clip positioned above the cooking liquid for straining of the food within the strainer-basket;

FIG. 4 is a cross-sectional view taken along lines 4-4 of FIG. 3 showing the disengagement of the clip mechanism with the strainer basket fully positioned within the container for cooking;

FIG. 5 is a cross-sectional view showing the engagement of the clip mechanism such that the strainer basket is raised and supported above the cooking liquid wherein the food is in the straining position;

FIG. 6 illustrates the apparatus of the invention with two strainer baskets within a larger container, each having the clip/support mechanism of the invention, one strainer basket in the cooking position and the other in the straining position;

FIG. 7 illustrates initial placement of the strainer basket support bracket within the clip of the invention;

FIG. 8 illustrates two strainer baskets within a larger container;

FIG. 9 illustrates an alternate design having a hook on the strainer basket;

FIG. 10 shows an alternate design of the strainer basket side panel supports;

FIG. 11 is an alternate design showing a flange instead of a clip for supporting the strainer basket; and

FIG. 12 is an alternate design showing an “L” shaped flange instead of a clip for supporting the strainer basket.

### DESCRIPTION

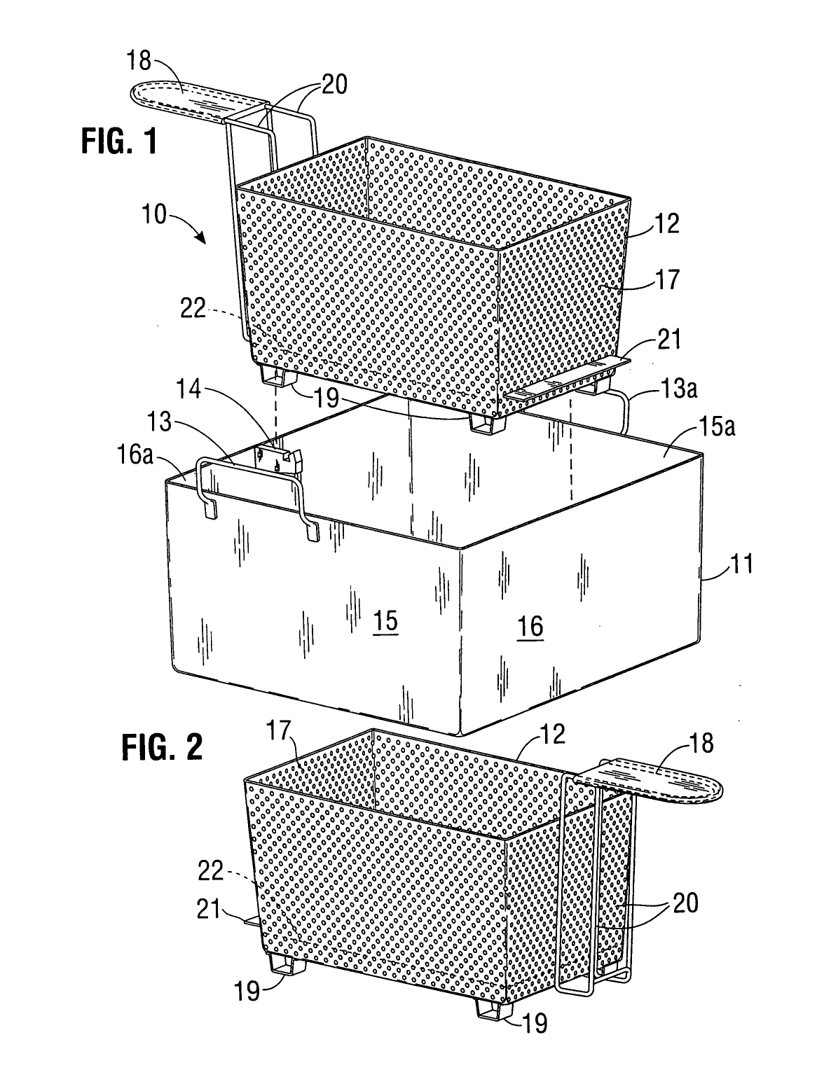

Referring now to the drawings in general, and initially to FIG. 1, there is shown in an exploded view, the cooking apparatus of the invention, generally designated 10. As shown, cooking apparatus 10 includes cooking container 11 and cooking strainer basket, generally designated 12; strainer basket 12 configured for fitting within cooking container 11. Container 11 includes clip 14 and may include handles 13, 13a placed along respective sides 15, 15a. Although container 10 and strainer basket 12 are indicated as rectangular in configuration having sides 15, 15a of one dimension and ends 16, 16a of another dimension, it is understood that different configurations, such as square, are within the scope of the invention. Further, although clip 14 is shown mounted to end 16a interior of container 11, it could as well be configured for replaceable fitting over, and/or for sliding along, end 16a.

Strainer basket 12 is shown to include a plurality of perforations, or draining holes, 17, a handle 18 mounted to a support member 20, a flange 21, and may include strainer basket risers, or feet, 19 (two shown). As indicated in dotted lines the bottom 22 of strainer basket 12 may be recessed upwardly within the sides of the container 11 to provide for improved circulation of the cooking liquid within the container 11.

FIG. 2 is a perspective view showing the strainer basket 12 of FIG. 1 rotated 180 degrees from the position as shown in FIG. 1. In this view the mounting of support member 20 and handle 18 to strainer basket 12 is more clearly shown.

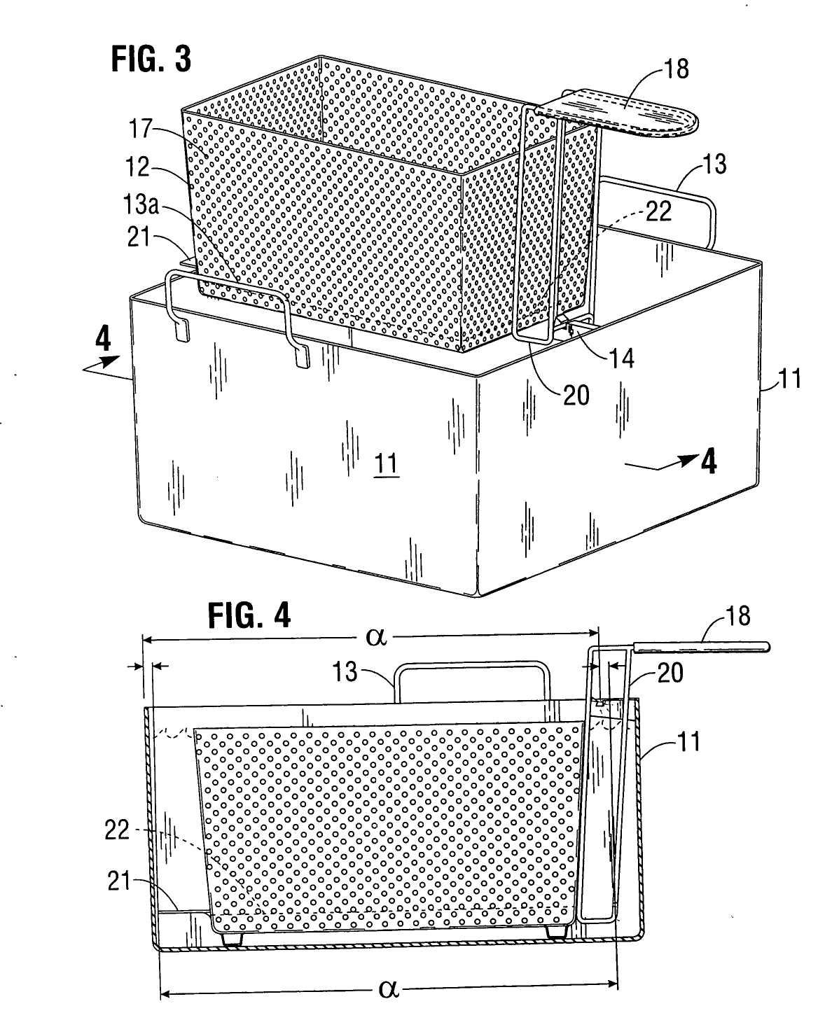

FIG. 3 is a perspective view of the cooking apparatus of FIG. 1 showing the strainer basket support member 20 engaged with the clip 14 of the container 11. In this manner strainer basket 12 is positioned above the cooking liquid for straining of the food within the strainer basket 12.

FIG. 4 is a cross-sectional view taken along lines 4-4 of FIG. 3 showing the disengagement of the support member 20 from the clip 14 with the strainer basket 12 fully positioned within the container 11 for cooking. As indicated by dimension “α” (in two places) the dimension from the outside of the rim of the container 11 to the engagement point of the clip 14 is essentially the same as the dimension from the end of flange 21 to a point between the engagement point of clip 14 and the inner wall of container 11. This allows the strainer basket 12 to be repositioned from the draining position to the cooking position. That is, the dimensions indicated by the opposing arrows (two places) are to be essentially equal.

Although the ends of strainer basket 12 are shown sloped downwardly and inwardly in FIG. 4, which may facilitate insertion of strainer basket 12 into container 11, it is not necessary in configuration and use of the invention. It is understood that the respective dimensions and configurations of the container 11 and the strainer basket 12 can be otherwise as described without deviating from the scope of the invention. Feet 19 may be included to provide for more complete circulation of the cooking liquid within the container 11.

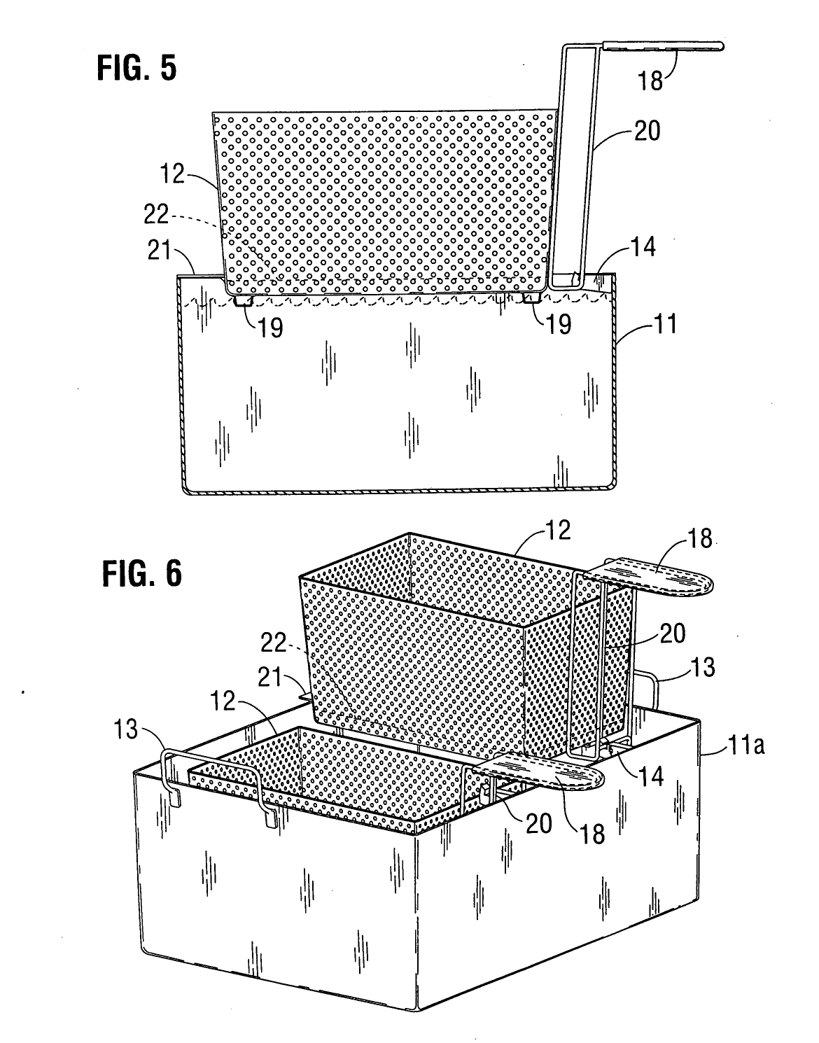

FIG. 5 is a cross-sectional view showing the engagement of the strainer basket 12 with the clip 14 such that the strainer basket 12 is raised and supported above the cooking liquid with the food then in the straining position. When strainer basket 12 is engaged with the clip 14 the strainer basket 12 is forced to the rear of the cooking container 11 so that the flange 21 protrudes over the top of, and rests on the top rim of, the cooking container 11.

FIG. 6 illustrates the apparatus of the invention with two strainer baskets 12 within a larger container 11a, one of the strainer baskets 12 in the cooking position with the other raised above the cooking liquid and thus in the food straining position. The strainer basket raised above the cooking liquid is supported by flange 21 resting on the top of container 11a as explained. That is, to engage support bracket 21 with clip 14 the strainer basket 12 is forced rearward to extend flange 21 over the top rim of container 11a.

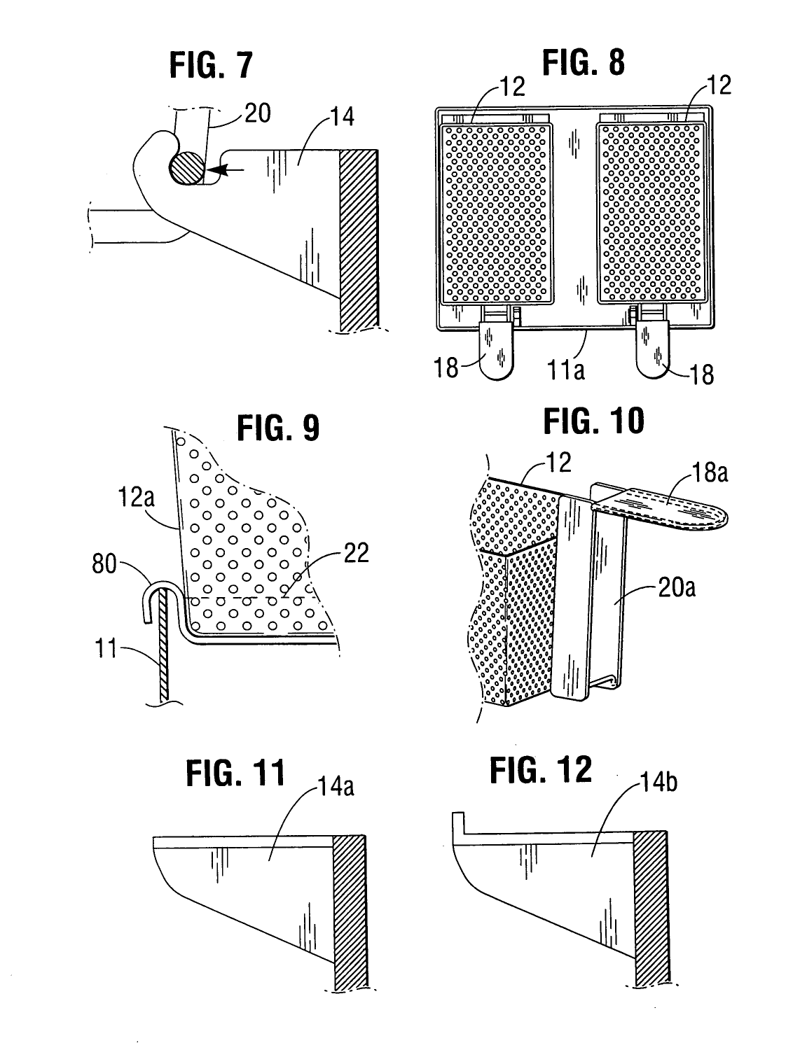

FIG. 7 illustrates placement of the strainer basket support member 20 within the clip 14. This is effected by initially placing the support member 20 within the vertical opening and then sliding it into the hooked potion of the clip 14.

FIG. 8 illustrates two strainer baskets 12 within a larger container 11a, each disengaged from clips 14. It is understood that the strainer baskets 12 and respective clips 14 can be positioned differently than as shown in this view.

FIG. 9 illustrates an alternate design wherein a strainer basket 12a has a hook-like member 80 for placement over the rim of container 11.

FIG. 10 shows as an alternate design support member 20a and handle 18a as may be used with strainer basket 12.

FIG. 11 shows an alternate design for clip 14 showing a flat flange member 14a for receiving support member 20.

FIG. 12 shows an alternate design for clip 14 showing an “L” shaped flange member 14b for receiving support member 20.

While the principles of the invention have been described and illustrated in a single embodiment, it will immediately be obvious to those skilled in the art that many modifications of structure, arrangement, proportions, materials, and components used in the practice of the invention can be particularly adapted for specific environments and operating requirements without departing from these principles.

What is claimed is:

1. Food cooking apparatus comprising:
a cooking container including a cooking liquid to be heated for cooking of food;
at least one removable food strainer basket containing said food positionable within said container for submerging within said cooking liquid for cooking of said food; and
said container and said strainer basket having coacting selectively positioned engagement means for positioning of said strainer basket above said cooking liquid for straining of said food.

2. The food cooking apparatus of claim 1 wherein said engagement means includes at least one container mounted inwardly extending support means for supporting said strainer basket within said container above said cooking liquid.

3. The food cooking apparatus of claim 2 wherein said engagement means further includes at least one strainer mounted support means exterior of said strainer basket for engagement with said container mounted support means.

4. The food cooking apparatus of claim 3 wherein said container mounted support means and said strainer basket mounted support means are disengaged to permit lowering of said strainer basket into said liquid for cooking of food contained therein and engaged to reposition said strainer basket sufficiently above said cooking liquid for straining of said food.

5. The food cooking apparatus of claim 4 wherein said strainer basket has first and second ends with said strainer basket mounted support means mounted on said first end of said strainer basket and said container mounted support means positioned for engagement with said strainer mounted support means; and
said second end including an extending flange proximate the bottom of said strainer basket for resting on the top rim of said container when said engagement means are engaged.

6. The food cooking apparatus of claim 5 wherein said container and said strainer basket are rectangular.

7. The food cooking apparatus of claim 6 wherein said strainer mounted support means includes handle means for manual repositioning of said strainer basket.

8. Food cooking apparatus comprising:
a cooking container containing a cooking liquid;
at least one strainer basket positioned in said cooking liquid for cooking of food in said strainer basket; and
said container and said strainer basket including coacting engagement means for repositioning said strainer basket above said cooking liquid for straining of said food.

9. The food cooking apparatus of claim 8 wherein
said container and said strainer basket are rectangular;
said strainer basket has first and second ends and said engagement means includes support means mounted on said first end thereof; and
said container includes complimentary support means positioned for engagement with said strainer basket support means.

10. The food cooking apparatus of claim 9 wherein said second end includes outwardly projecting flange means configured for resting on the top edge of said container when said engagement means are engaged.

11. The food cooking apparatus of claim 10 wherein said first and second strainer basket ends slope downwardly and inwardly to facilitate insertion of said strainer basket into said container when said engagement means are disengaged.

12. The food cooking apparatus of claim 10 wherein the bottom of said strainer basket is recessed upwardly within the sides of said strainer basket to provide improved circulation of said cooking liquid within said container.

13. The food cooking apparatus of claim 10 wherein said strainer basket includes riser footings for providing improved circulation of said cooking liquid within said container.

14. Food cooking apparatus comprising:
a cooking container having cooking liquid therein with at least one strainer basket positioned in said cooking liquid for cooking of food in said strainer basket;
said container and said strainer basket are rectangular with said strainer basket having first and second ends;
said first end of said strainer basket includes first support means located proximate the bottom of said strainer basket and said container includes second support means located proximate the top of said container: and
said first and second support means positioned for engagement whereby said strainer basket is supported above said cooking liquid for straining of said food in said strainer basket.

15. The food cooking apparatus of claim 14 wherein said second end of said strainer basket includes an outwardly extending flange located proximate the bottom of said strainer basket for positioning on the top of said container for supporting the second end of said strainer basket during straining of said food.

16. The food cooking apparatus of claim 15 wherein the bottom of said strainer basket is recessed upwardly within the sides of said strainer basket to provide improved circulation of said cooking liquid within said container.

17. The food cooking apparatus of claim 15 wherein said first and second strainer basket ends are configured sloping downwardly and inwardly to facilitate insertion of said strainer basket into said container when said engagement means are disengaged: and
said strainer basket includes riser footings for providing improved circulation of said cooking liquid within said container.
